(19) United States
(12) Patent Application Publication
(10) Pub. No.: US 2012/0216221 A1
(43) Pub. Date: Aug. 23, 2012

(54) METHOD FOR CALIBRATING STEPS OF STEPPING MOTOR USED IN OPTICAL DISC DRIVE

(75) Inventors: I-Bing SU, Taoyuan County (TW); Yi-Long Hsiao, Taoyuan County (TW)

(73) Assignee: QUANTA STORAGE INC., Taoyuan County (TW)

(21) Appl. No.: 13/368,362

(22) Filed: Feb. 8, 2012

(30) Foreign Application Priority Data
Feb. 22, 2011 (TW) 100105971

(51) Int. Cl. G11B 7/085

(52) U.S. Cl. 720/672; G9B/7.042

(57) ABSTRACT

A method for calibrating steps of a stepping motor used in an optical disc drive is provided. A pick-up head is moved to an origin of the structure. The pick-up head is moved toward a terminal of the structure by a stepping motor. The steps of the stepping motor are recorded until a counter electromotive force of the stepping motor is detected. A predetermined travel distance of the pick-up head is calculated. If the predetermined travel distance of the pick-up head is different from the maximum distance of the structure, then it is decided that the stepping motor has step error, and the steps of the stepping motor are calibrated.

This application claims the benefit of Taiwan application Serial No. 100105971, filed Feb. 22, 2011, the subject matter of which is incorporated herein by reference.

### BACKGROUND OF THE INVENTION

### Field of the Invention

The invention relates in general to an optical disc drive which reads/writes an optical disc, and more particularly to a method for calibrating the error between the steps of the stepping motor and the travel distance of the pick-up head used in an optical disc drive.

### Description of the Related Art

As the data density of an optical disc increases, the power for moving the pick-up head of the optical disc drive also changes to stepping motor from DC motor to increase the precision of movement of the pick-up head in order to read/write the data on the optical disc more precisely.

Referring to FIG. 1, a flowchart of a method for calibrating the steps of a stepping motor according to the prior art is shown. Referring to a prior art disclosed in Taiwanese Patent Publication No. 200516581. The above prior art discloses a method for calibrating the step error of the stepping motor which occurs due to the assembly of the optical disc drive. When an optical disc is loaded to the optical disc drive and the power is turned on (step P1), the stepping motor is controlled to move the pick-up head to jump the tracks for predetermined steps along the radial direction of the optical disc (step P2). When jumping the tracks, the number of tracks jumped over is calculated according to the detected number of peaks generated by the tracking error signal (step P3). As the optical disc has a specific gauge, the actual travel distance of the pick-up head can be obtained from the product of the track count multiplied by the gauge (step P4). The proportional relationship between the steps of the stepping motor and the travel distance of the pick-up head is calibrated according to the error between the distance that the pick-up head should have jumped over per predetermined steps controlled by stepping motor and the actual travel distance of the pick-up head so as to increase the precision in the movement of the pick-up head. The detection in the track count based on the number of tracks that the pick-up head should have jumped over per predetermined steps may be incorrect due to the scratch, tarnish or dust on the optical disc or signal interference, and the resulted calibration is also incorrect. Furthermore, according to the calibrating method disclosed in the prior art, each optical disc drive is calibrated whenever the system is started up, and the required operation procedure is much more complicated and time-consuming. Therefore, the method for calibrating the steps of a stepping motor used in an optical disc drive still has many problems to tackle with.

### SUMMARY OF THE INVENTION

The invention is directed to a method for calibrating the steps of a stepping motor used in an optical disc drive. The steps of the stepping motor are calibrated according to the error between the maximum distance of the pick-up head driven by the stepping motor and the actual travel distance of the pick-up head when a counter electromotive force of the stepping motor is detected so as to increase the calibration accuracy.

The invention is further directed to a method for calibrating the steps of a stepping motor used in an optical disc drive in which the step error is decided before step calibration is performed so as to increase calibration efficiency.

To achieve the above objects, the present invention discloses a method for calibrating steps of a stepping motor used in an optical disc drive. A pick-up head is moved to an origin of the structure. The pick-up head is moved toward a terminal of the structure by a stepping motor. The steps of the stepping motor are recorded until a counter electromotive force of the stepping motor is detected. A predetermined travel distance of the pick-up head is calculated. If the predetermined travel distance of the pick-up head is equal to the maximum distance of the structure, then it is decided that the stepping motor does not have step error. If the predetermined travel distance of the pick-up head is different from the maximum distance of the structure, then it is decided that the stepping motor has step error, and the steps of the stepping motor are calibrated on the basis of the maximum distance of the structure according to the error between the maximum distance of the structure and the predetermined travel distance of the pick-up head.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a flowchart of a method for calibrating the steps of a stepping motor according to the prior art;

FIG. 2 shows a schematic diagram of a method for calibrating the steps of a stepping motor used in an optical disc drive according to the invention;

FIG. 3 shows a flowchart of a method for calibrating the steps of a stepping motor used in an optical disc drive according to the invention.

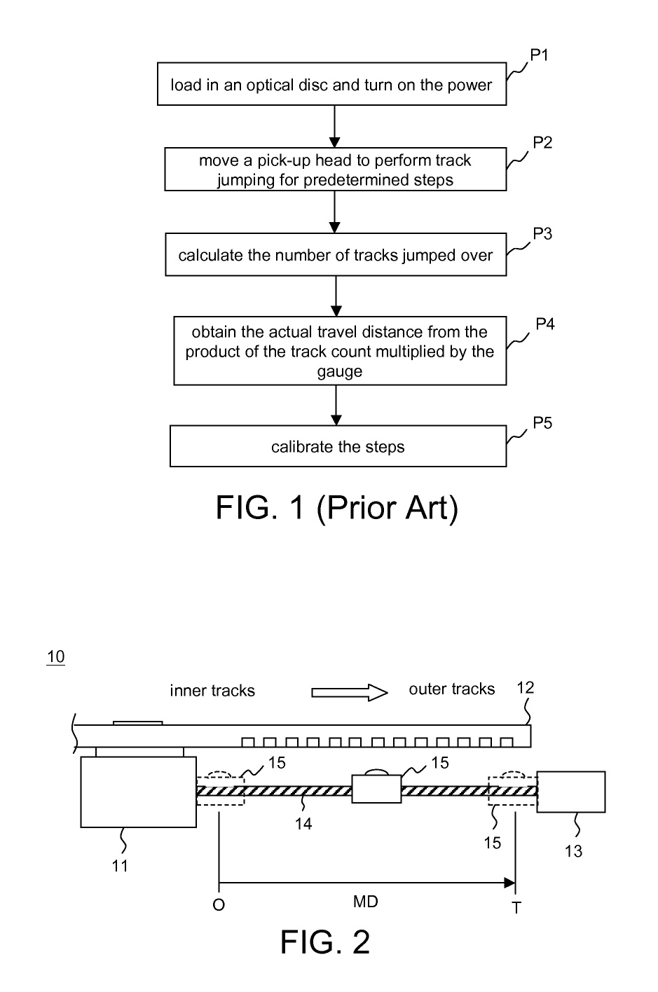

### DETAILED DESCRIPTION OF THE INVENTION

The above and other aspects of the invention will become better understood with regard to the following detailed description of the non-limiting embodiment(s). The following description is made with reference to the accompanying drawings.

Referring to FIG. 2, a schematic diagram of a method for calibrating the steps of a stepping motor used in an optical disc drive according to the invention is shown. The optical disc drive 10 according to the invention rotates an optical disc 12 with a spindle motor 11. A pick-up head 15 is driven by a screw rod 14 rotated by the stepping motor 13 to move reciprocally to read/write the data on the optical disc 12 along a radial direction of the optical disc 12. The data on the optical disc 12 is normally arranged from inner tracks to outer tracks in a direction indicated by the arrow of FIG. 2. The screw rod 14 is rotated to transmit the pick-up head 15 forward. One end of the screw rod 14 near the inner tracks of the optical disc 12 is blocked by the spindle motor 11, and marks a starting point for the movement of the pick-up head 15 which is also referred as the origin O of the structure. The other end of the screw rod 14 near the outer tracks of the optical disc 12 is connected to the stepping motor 13, and marks an end point for the movement of the pick-up head 15 as the pick-up head 15 is blocked by the stepping motor 13. The end point for the movement of the pick-up head 15 is also referred as the terminal T of the structure. Thus, the stepping motor 13 can only drive the pick-up head 15 to move between the origin O of the structure and the terminal T of the structure. The distance from the origin O of the structure to the terminal T of the structure is referred as the maximum distance MD for the movement of the pick-up head 15, and can be measured and stored as a specific length of the optical disc drive 10.

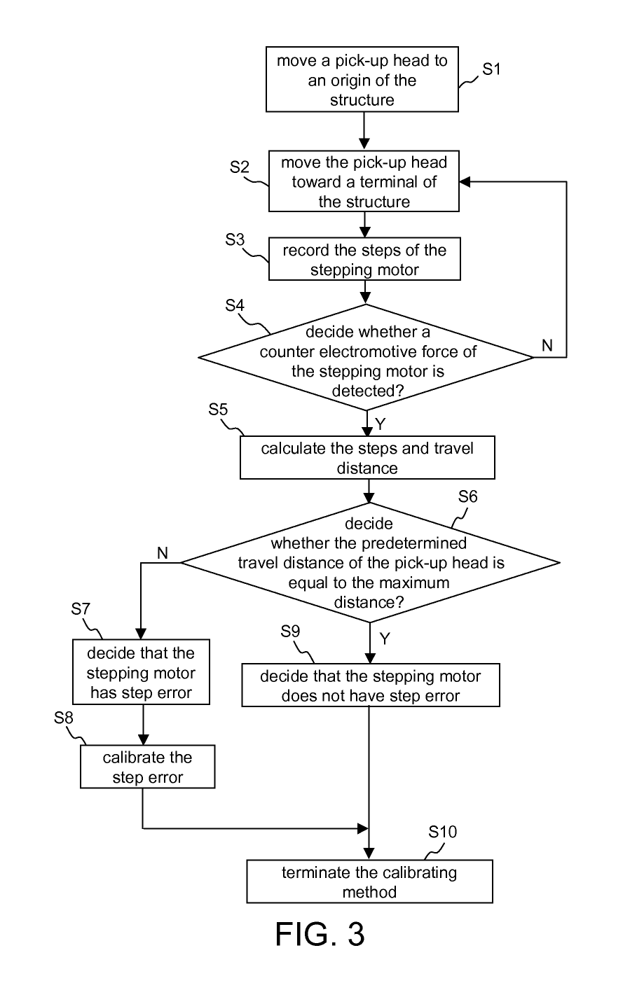

The maximum travel distance of the pick-up head 15 must include the radial length of the data region of the optical disc 12 so that the stepping motor 13 can drive the pick-up head 15 to read/write the data on the optical disc 12 without obstruction. As indicated in FIG. 3, when the stepping motor 13 moves the pick-up head 15 to the origin O of the structure or the terminal T of the structure, the pick-up head 15 will be blocked by the spindle motor 11 or the stepping motor 13 and cannot move any further, and the counter electromotive force of the stepping motor 13 will boost accordingly. The above process can be detected from the variation in the counter electromotive force level (high level or low level) getting from the control system of the stepping motor 13.

When calibrating the steps of the stepping motor 13 according to the method of the present invention, first of all, the pick-up head 15 is moved to the origin O of the structure by the stepping motor 13, and then it can be confirmed that the pick-up head 15 is correctly located at the origin O of the structure as soon as the counter electromotive force of the stepping motor 13 boosts to the high level when the pick-up head 15 touches the spindle motor 11. The stepping motor 13 is driven by the pulse voltage, and one unit pulse voltage enables the stepping motor 13 to rotate to a fixed angle, which rotates the screw rod 14 to drive the pick-up head 15 to move for a unit distance, which is also referred as “step”. Then, a pulse voltage is supplied to the stepping motor 13 for moving the pick-up head 15 toward the terminal T of the structure, the number of times of supplying the pulse voltage is counted, and the steps of the stepping motor 13 are recorded. Then, it can be confirmed that the pick-up head 15 reaches the terminal T of the structure when the pick-up head 15 is blocked and the counter electromotive force of the stepping motor 13 boosts to the high level. Then, a predetermined travel distance of the pick-up head 15 is obtained from the product of the required number of steps of the stepping motor 13 for the pick-up head 15 to reach the terminal T of the structure multiplied by the unit distance of each step, and the predetermined travel distance is further compared with the maximum distance MD of the structure. It can be decided that the stepping motor does not have step error and the steps of the stepping motor are correct and do not need to be calibrated if the predetermined travel distance of the pick-up head 15 is equal to the maximum distance MD. To the contrary, it can be decided that the step moor has step error and the steps of the stepping motor are incorrect and need to be calibrated if the predetermined travel distance of the pick-up head 15 is different from the maximum distance MD.

Referring to FIG. 3, a flowchart of a method for calibrating the steps of a stepping motor used in an optical disc drive according to the invention is shown. The details for calibrating the steps of the stepping motor according to the method of the invention are disclosed below. First, in step S1, a pick-up head is moved to the origin of the structure by the stepping motor. Next, in step S2, the pick-up head is moved toward the terminal T of the structure by the stepping motor. Then, in step S3, the steps of the stepping motor are recorded. In step S4, whether a counter electromotive force of the stepping motor is detected is decided. If no counter electromotive force of the stepping motor is detected, then return to step S2, the pick-up head is moved continually. If the counter electromotive force of the stepping motor is detected, then it is confirmed that the pick-up head arrives the terminal T of the structure, and proceed to step S5. In step S5, a predetermined travel distance of the pick-up head is obtained from the steps recorded in step S3. Then, in step S6, whether the predetermined travel distance of the pick-up head is equal to the maximum distance MD is decided. If the predetermined travel distance of the pick-up head is different from the maximum distance

MD, then proceed to step S7. If the predetermined travel distance of the pick-up head is equal to the maximum distance MD, then proceed to step S9. In step S7, whether the stepping motor has step error is decided. Then, in step S8, the steps of the stepping motor are calibrated according to the error between the maximum distance MD and the predetermined travel distance of the pick-up head driven by the stepping motor. Then, the method proceeds to step 10. In step S9, the steps of the stepping motor are correct and do not need to be calibrated if it is decided that the stepping motor does not have step error. Then, in step 10, the method for calibrating the steps of the stepping motor terminates.

According to the method for calibrating the steps of a stepping motor used in an optical disc drive of the present invention, the counter electromotive force of the stepping motor, the steps of the stepping motor and a specific maximum distance of the structure used in the optical disc drive can be detected through the control system of the optical disc drive, and whether the stepping motor has step error can be decided according to a simple calculation of the movement of the pick-up head without using complicated detection obtained by track jumping signals. Thus, the calibration procedure for the optical disc drive which is free of error in assembly is excluded so as to increase the calibration efficiency. As for the optical disc drives which require calibration for step error, the steps of the stepping motor are calibrated on the basis of the maximum distance of the structure according to the error between the maximum distance of the structure and the predetermined travel distance of the pick-up head so as to increase the calibration efficiency.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for calibrating steps of a stepping motor used in an optical disc drive, wherein the method comprises:
(1) moving a pick-up head to an origin of an structure by a stepping motor;
(2) moving the pick-up head toward a terminal of the structure by the stepping motor;
(3) recording the steps of the stepping motor;
(4) deciding whether a counter electromotive force of the stepping motor is detected: the method returns to step (2) if no counter electromotive force of the stepping motor is detected and proceeds to step (5) if the counter electromotive force of the stepping motor is detected;
(5) calculating a predetermined travel distance of the pick-up head;
(6) deciding whether the predetermined travel distance of the pick-up head is equal to the maximum distance of the structure: the method proceeds to step (7) if the predetermined travel distance of the pick-up head is different from the maximum distance of the structure, and proceeds to step (8) if the predetermined travel distance of the pick-up head is equal to the maximum distance of the structure;
(7) deciding that the stepping motor has step error and calibrating the steps of the stepping motor; and
(8) deciding that the stepping motor does not have step error.

2. The method for calibrating steps of a stepping motor used in an optical disc drive according to claim 1, wherein the steps of the stepping motor are calibrated on the basis of the maximum distance of the structure according to the error between the maximum distance of the structure and the predetermined travel distance of the pick-up head.

3. The method for calibrating steps of a stepping motor used in an optical disc drive according to claim 1, wherein there is no need to calibrate the steps of the stepping motor if it is decided that the stepping motor does not have step error.

4. The method for calibrating steps of a stepping motor used in an optical disc drive according to claim 1, wherein whether the pick-up head is located at the origin of the structure or the terminal of the structure is confirmed through an increase in the counter electromotive force of the stepping motor.

5. The method for calibrating steps of a stepping motor used in an optical disc drive according to claim 1, wherein the predetermined travel distance of the pick-up head is a product of the recorded steps of the stepping motor multiplied by the unit distance of each step.

6. The method for calibrating steps of a stepping motor used in an optical disc drive according to claim 1, wherein the maximum distance of the structure is the distance from the origin of the structure to the terminal of the structure.

7. The method for calibrating steps of a stepping motor used in an optical disc drive according to claim 6, wherein the maximum distance of the structure is measured and stored as a specific length of the optical disc drive.
